(19) United States
(12) Patent Application Publication
(10) Pub. No.: US 2026/0099131 A1
(43) Pub. Date: Apr. 9, 2026

(54) MANAGEMENT OF MACHINE OPERATION SAFETY ZONES

(71) Applicant: Caterpillar Inc., Peoria, IL (US)

(72) Inventors: Mark W. WHITING, Peru, IL (US); Gautham SUBRAMANIAN, Thazhambur (IN)

(73) Assignee: Caterpillar Inc., Peoria, IL (US)

(21) Appl. No.: 18/907,093

(22) Filed: Oct. 4, 2024

(51) Int. Cl. G05B 19/406

(52) U.S. Cl. CPC G05B 19/406; G05B 2219/31304

(57) ABSTRACT

A method for determining a safety zone includes receiving work site data, receiving material characteristic data corresponding to the points of the site represented by the work site data, and determining an actual site model. The method further includes determining a desired site model representing the site at a future time, comparing the actual site model to the desired site model to determine a difference model that includes a safety zone in which a machine speed, a machine type, or a quantity of machines, is limited or prohibited, the safety zone being determined based on a material characteristic associated with material that corresponds to the safety zone, the material characteristic being represented in the material characteristic data, one or more areas outside of the safety zone having a different material characteristic, and determining a work plan based on the difference model, the work plan including the safety zone.

### TECHNICAL FIELD

The present disclosure relates generally to worksite management, and more particularly, to a system for controlling or supervising machines that operate at a worksite.

### BACKGROUND

Industrial machines perform a variety of different tasks across a worksite, including earthmoving, mining, boring, and paving. Many worksites contain harsh conditions, such as strong or severe weather events, steep inclines, and loose material, which are hazardous in at least some circumstances. Conventionally, operators rely on experience to avoid these and other hazards and operate the machine in a safe manner. Industrial machines, including autonomously controlled machines, semi-autonomously controlled machines, remotely controlled machines, and manually controlled machines are also provided with safeguards (e.g., via programming) that prevent unsafe conditions. For example, a machine may generate an alert when the machine is tilted at a particular angle or more. However, these techniques are typically remedial and do not proactively identify a hazard in at least some situations. These systems may also fail to account for characteristics of the material on the worksite, changes to the worksite over time, including changes due to work performed at the worksite (e.g., excavation, grading, ripping, blasting, drilling, etc.), changes in external conditions (e.g., precipitation, temperature, etc.), and others.

A worksite monitoring system is described in U.S. Patent No. 10,684,137 (“the ’137 patent”) to Kean. The monitoring system generates worksite maps based on aerial images. These maps provide information such as task or job progress, worksite images, mapping information, and status information of the worksite and/or of vehicles on the worksite. A control center receives and stores data, such as fleet data, service data, job or planning data, and personnel data. While the worksite maps of the ’137 patent may be helpful for viewing a completed portion of work, it is not able to identify potentially unsafe areas and designate safety zones according to potentially unsafe areas and/or other areas.

The methods and systems of the present disclosure may solve one or more of the problems set forth above and/or other problems in the art. The scope of the protection provided by the present disclosure, however, is defined by the attached claims, and not by the ability to solve any specific problem.

### SUMMARY

In one aspects, a method for determining a safety zone may include receiving work site data representing points of a site in which work is to be performed, receiving material characteristic data, the material characteristic data corresponding to the points of the site represented by the work site data, and determining an actual site model that is a representation of the site at a current time or at a previous time, the actual site model being based on the work site data. The method may further include determining a desired site model that is a representation of the site at a future time, comparing the actual site model to the desired site model to determine a difference model that includes a safety zone in which a machine speed, a machine type, or a quantity of machines, is limited or prohibited, the safety zone being determined based on a material characteristic associated with material that corresponds to the safety zone, the material characteristic being represented in the material characteristic data, one or more areas outside of the safety zone having a different material characteristic, and determining a work plan based on the difference model, the work plan including the safety zone.

In another aspect, a system for predicting conditions of one or more components of a machine may include one or more processors and at least one non-transitory computer readable medium storing instructions which, when executed by the one or more processors, cause the one or more processors to perform operations. The operations may include receiving work site data representing points of a site in which work is to be performed, receiving material characteristic data, the material characteristic data corresponding to the points of the site represented by the work site data, and determining an actual site model that is a representation, in three dimensions, of the site at a current time or at a previous time, the actual site model being based on the work site data. The operations may further include determining a desired site model that is a representation, in three dimensions, of the site at a future time, based on the actual site model and the desired site model, determining a safety zone in which a machine type or a quantity of machines is limited or prohibited, the safety zone being determined based on a material characteristic associated with material that corresponds to the safety zone, the material characteristic being represented in the material characteristic data, one or more areas outside of the safety zone having a different material characteristic, and causing display of a representation of the safety zone on the site.

In yet another aspect, a non-transitory computer readable medium, the non-transitory computer readable medium storing instructions for predicting conditions of one or more components of a machine which, when executed by one or more processors of a computing system, cause the one or more processors to perform operations. The operations may include receiving work site data representing points of a site in which work is to be performed, receiving material characteristic data, the material characteristic data corresponding to the points of the site represented by the work site data, determining an actual site model that is a representation, in three dimensions, of the site at a current time or at a previous time, the actual site model being based on the work site data. The operations may further include determining a desired site model that is a representation, in three dimensions, of the site at a future time, based on the actual site model and the desired site model, determining a safety zone in which a machine type or a quantity of machines is limited or prohibited, the safety zone being determined based on a material characteristic associated with material that corresponds to the safety zone, the material characteristic being represented in the material characteristic data, one or more areas outside of the safety zone having a different material characteristic, causing display of a representation of the safety zone on the site.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a schematic diagram of a safety zone system, according to aspects of the disclosure.

FIG. 2 is a block diagram of a safety zone analyzer of the safety zone system of FIG. 1.

FIG. 3 is an image of an exemplary display illustrating safety zones determined with the safety zone system of FIG. 1.

FIG. 4 is a flowchart illustrating an exemplary method for determining a safety zone.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Moreover, in this disclosure, relative terms, such as, for example, “about,” “substantially,” “generally,” and “approximately” are used to indicate a possible variation of ±10% in the stated value. As used herein, the phrase “based on” encompasses the phrases “based in part on” and “based entirely on.”

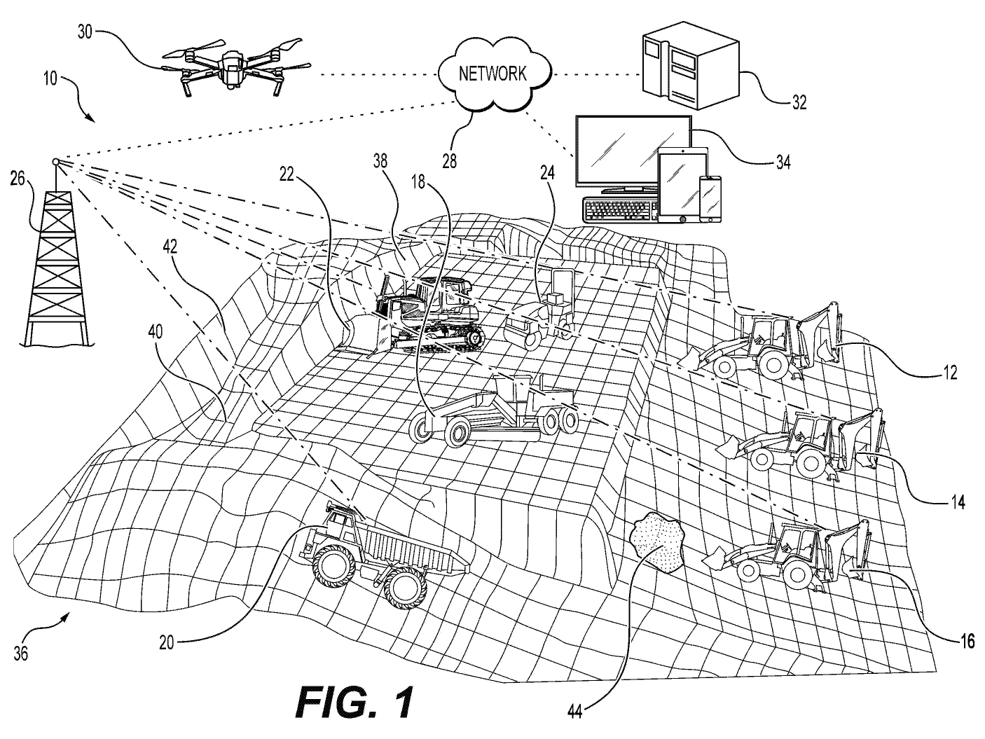

FIG. 1 is a partially-schematic diagram illustrating a worksite 36 and components of a safety zone system 10. As shown in FIG. 1, system 10 may include a plurality of machines configured to operate on worksite 36, a communication network, and one or more systems configured to determine safety zones that correspond to locations on worksite 36. In particular, FIG. 1 illustrates machines that include loaders 12, 14, and 16, a grader 18, a haul truck 20, and a compactor 24, a network that includes local communication network 26 and an external communication network 28, and computing systems including backend system 32 and operator system 34. As described below, system 10 may further include systems that are configured to generate site modelling data (e.g., an electronic representation, such as a three-dimensional model, of one or multiple areas of worksite 36). Suitable systems for generating modelling data include a flight-capable survey device 30, a ground-based survey device such as a rover (not shown), machine-vision or scanning systems mounted on one or mobile machines 12-24, or stationary components at one or more locations of worksite 36.

In the illustrated example, machines 12, 14, 16, 20, 22, and 24 (also collectively referred to herein as “machines”) are configured to perform excavation work, including material loading via loaders 12, 14, 16, material hauling via hauler 20, grading via grader 18 and/or machines 22, and compacting via compactor 24. Other suitable machines include paving machines, mining machines, forestry machines, drilling machines, pipe laying machines, and others. In the illustrated example, each of the machines is in communication with local communication network 26 and external communication network 28 via communication devices (e.g., transmission devices, receiving devices, etc.) on the machines of system 10. These communication systems may allow one or multiple machines to be placed under fully autonomous control, semi-autonomous control, and/or remote control. While each machine is shown as being in communication with local communication network 26, in other examples the machines are in communication with external communication network 28, either directly or indirectly. Further, one or more machines of system 10 may be manually operated (e.g., a machine in which an operator is present in a cabin of the machine) and/or not in communication with local communication network 26 or external communication network 28.

Local communication network 26 may include on-site components to securely control or monitor machines at worksite 36. The components of local communication network 26 may be configured for line-of-sight or other types of communication with the machines of system 10. Local communication network 26 may also facilitate communication with external (e.g., off-site) systems, such as backend system 32 and operator system 34, by communication with network 28. However, in at least some configurations, system 10, including backend system 32 and operator system 34, are implemented locally, without use of off-site systems and/or the internet.

While local communication network 26 and external communication network 28 are shown in FIG. 1, system 10 may be connected to one or more networks instead of or in addition to networks 26 and 28. Suitable networks for system 10, including networks 26, 28, may include wired or wireless networks. The wireless network may be a cellular telephone network, an 802.11, 802.16, 802.20, or WiMax network. Further, such networks may include a public network, such as the Internet, a private network, such as an intranet, or combinations thereof, and may utilize a variety of networking protocols now available or later developed including, but not limited to TCP/IP based networking protocols. Networks 26 and 28 may include wide area networks (WAN), such as the Internet, local area networks (LAN), campus area networks, metropolitan area networks, a direct connection such as through a Universal Serial Bus (USB) port, or any other networks that may allow for data communication. Networks 26 and 28 may be configured to couple one computing device to another computing device to enable communication of data between the devices. Networks 26 and 28 may generally be enabled to employ any form of machine-readable media for communicating information from one device to another. Networks 26 and 28 may include communication methods by which information may travel between computing devices. Networks 26 and 28 may be divided into sub-networks. The sub-networks may allow access to all of the other components connected thereto or the sub-networks may restrict access between the components. Networks 26 and 28 may be regarded as a public or private network connection and may include, for example, a virtual private network or an encryption or other security mechanism employed over the public Internet, or the like.

Data transmitted over networks 26 and 28 may include images, videos, machine commands, sensor data, maps, and other data types. In some aspects, networks 26 and 28 facilitate communication of data that represent machine type, machine availability, signal from machine sensors, an actual or current condition of worksite 36, a planned or desired condition of worksite 36, material density data, material type data, topology data, environmental data, work schedule data, operator or other personnel data, and data associated with costs of particular activities on worksite 36.

Backend system 32 may include one or more computing systems configured to operate to facilitate worksite planning, worksite supervision, and machine control. For worksite planning, backend system 32 may receive a model that represents the current condition of worksite 36 or a previous (e.g., a recent) condition of worksite 36. This model, also referred to as a “current” site model, may be a point cloud or other representation of worksite 36. Preferably, the model is a three-dimensional model that represents the heights of material and the surface of the ground at locations within worksite 36. Backend system 32 may receive or generate the current site model, the term “determining” encompassing receiving the current site model, generating the current site model, providing the current site model, etc.

The current site model may be generated based on survey data. In the illustrated example, survey data may be generated with a survey device 30. In addition or as an alternative to survey device 30, the survey data may include data obtained by a rover (e.g., an automated ground-traversing device) and/or data obtained by sensors mounted on the machines of system 10. Survey data may include data generated with light detection and ranging (LIDAR) devices, radar devices, a sonar devices, imaging devices (e.g., charge coupled devices, complementary metal oxide semiconductor devices, stereoscopic cameras, infrared cameras, etc.), and other sensors and devices for detection of objects. The survey data may be provided in any suitable format and/or data type. For example, the survey data may be provided to system 32 or system 34. A suitable system, such as system 32 or system 34, may receive the survey data and convert the data to suitable coordinate system data. The coordinate system data may represent points in three dimensions of space and may be calibrated (e.g., rotates, translates, re-sizes, or otherwise transforms) with system 32 or system 34.

Backend system 32 may be further configured to determine (receive or generate) a desired site model. The desired site model may represent a future or desired condition of worksite 36 once work is performed. The desired site model may represent a desired final condition of worksite 36, or an intermediate condition that represents a future of condition of worksite 36 that will be further modified to achieve the final desired condition of worksite 36. The desired site model may be a three-dimensional model in which points or portions correspond to the same or similar points or portions of the current site model.

Operator system 34 may correspond to one or more systems of the machines of system 10, mobile computing systems (e.g., cellular phones, tablet devices, laptops, etc.) of one or more machine operators, in-machine systems (e.g., on-board computing systems), or other systems that facilitate an operator’s use or supervision of one or more of machines 12, 14, 16, 18, 20, 22, 24. In at least some configurations, operator system 34 controls an operation of one or more of these machines based on safety zones that are generated with backend system 32 or with operator system 34. Operator system 34 may be configured to display alerts illustrating safety zones, display safety zones of worksite 36, allow a user to manually edit, add, or reject safety zones, etc.

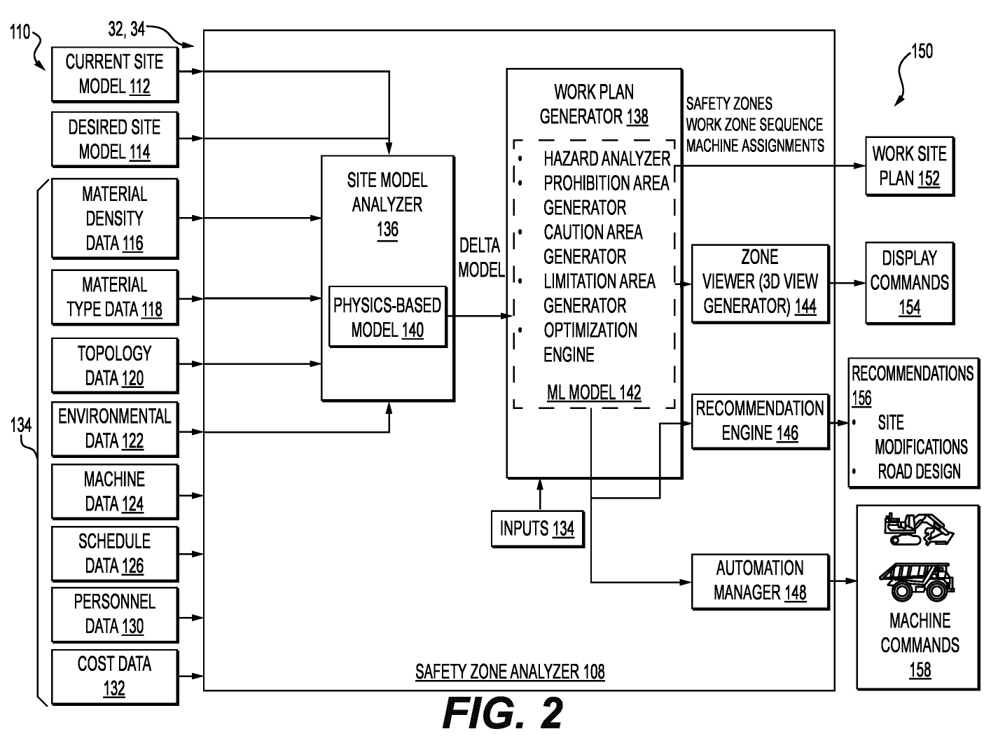

Systems 32 and 34 may be configured to receive signals from other computing devices and sensors of system 10 (e.g., for collecting survey data or any data described herein, including inputs 110 (FIG. 2) as described below). In some configurations, systems 32 and 34 are located on-board or off-board the machines of system 10 and are configured to monitor and control operation of the machines as well as monitor operation of these machines across one or multiple safety zones. Systems 32 and 34 may be in communication with one or more additional systems, and may be distributed across a plurality of systems 32 and 34. In some configurations, the operations of systems 32 and 34 are performed by the same system(s) (e.g., systems 32 and 34 may be implemented as the same system or the same group of systems).

Systems 32 and 34 may each embody a single processor or multiple processors that receive inputs and generate outputs. Systems 32 and 34 may each include a memory, a secondary storage device, at least one processor such as a central processing unit, or any other means for accomplishing a task consistent with the present disclosure, as described below. The memory or secondary storage device associated with systems 32 and 34 may store data and software to allow systems 32 and 34 to perform functions, including the functions described below with respect to method 400. Numerous commercially available microprocessors can be configured to perform the functions of systems 32 and 34. Various other known circuits may be associated with systems 32 and 34, including current monitoring circuitry, signal-conditioning circuitry, communication circuitry, and other appropriate circuitry.

FIG. 2 is a block diagram illustrating an exemplary configuration of a safety zone analyzer 108 that may be implemented with systems 32 and/or systems 34. As shown in FIG. 2, safety zone analyzer 108 may receive inputs 110, which include site model inputs and work inputs 134. The site model inputs for safety zone analyzer 108 may include data representing prior, current, or future conditions of worksite 36. The site model inputs may include current site model 112 and desired site model 114, either as complete models or as survey data (e.g., in the form of sensor data).

Work inputs 134 may include data (e.g., data 116, 118, 120, 122, 124, 126, 130, 132, described below) that is useful for generating a work plan, including safety zones, for worksite 36. These inputs may be used, for example, to identify areas that are potentially unsafe for one or more actions, as well as areas that are deemed to be generally safe. Work inputs 134 may also include data that facilitate optimization of safety zone generating algorithms, ensuring that safety zones have minimal impact on operational costs, work schedules, etc.

Inputs 110 may be received and/or processed with a site model analyzer 136, a work plan generator 138, a zone viewer 144, a recommendation engine 146, or an automation manager 148 of safety zone analyzer 108. Analyzer 136, as shown in FIG. 2, may receive current site model 112 and desired site model 114. As described above, current site model 112 and desired site model 114 may be three-dimensional models. Desired site model 114 may represent the same worksite 36 as current site model 112, which areas of model 114 matching corresponding areas of 112. Changes between current site model 112 and desired site model 114 may represent changes achieved by excavation tasks, paving tasks, mining tasks, and/or other tasks performed with the machines of system 10.

Models 112 and 114 may be generated with commercially-available software (e.g., suitable computer-aided design software, such as AutoCAD) or with software specific to the particular construction activity (e.g., excavation planning software, paving planning software, mining planning software, etc.). Models 112 and 114 may be generated based on survey data from rovers, positioning data (e.g., GPS data, data from another global navigation satellite system, data from positioning sensors located at worksite 36), surface mapping data (e.g., aerial photogrammetry performed with survey device 30),

Material density data 116 may represent the weight for a particular volume of material (e.g., in kg/m³, lb/yd³, etc.). Material density data 116 may be associated with particular areas of worksite 36, such that material density data 116 is assignable to various locations (e.g., individual pixels or points in three dimensional space, or groups of pixels or points) of models 112 and 114. Material density data 116 may include location data that associates a particular density value with a two-dimensional or three-dimensional set of points or coordinates. Material density data 116 may be determined based on sample analysis (e.g., soil analysis), manually-set values (e.g., values determined by an operator and provided via an input device), values associated with a particular material type (e.g., values based on material type data 118), or default values. Material density data 116 may specify moisture content or degree of compaction (e.g., whether the material is damp, wet, dry, loose, and/or compacted).

Material type data 118 may identify a particular type of material that is associated with particular areas of worksite 36. Material type data 118 may also be assignable to locations of current site model 112 and models 114. Material type data 118 may be determined via soil analysis, be manually-set, set as a default value, determined based on visual analysis (e.g., image recognition performed on images from survey device 30, a machine, or another device), etc. Example material types in data 118 may include clay, gravel, sand, stone, top soil, etc.

Topology data 120 may represent the surfaces at portions of worksite 36. Topology data 120 may indicate surface slope, elevation changes, and other indicates of geometric relationships. Data 120 may be used to determine locations of points in models 112 and 114, and may be based on map data, survey data, data for a geographic information system (GIS), etc. If desired, topology data 120 may be included in site model 112 (e.g., model 112 and data 120 may be the same). Topology data 120 may be in the form of points, lines, polygons, nodes, edges, faces, etc.

Environmental data 122 may include information relating to weather events (e.g., short-term weather data), climate, typical conditions, etc. For example, environmental data 122, may include weather data over a set period of time (e.g., a 6-hour, 8-hour, 10-hour, 24-hour period of time, etc.). This weather data may include likelihood of precipitation, quantity of precipitation, humidity, UV index, wind speed, wind direction, severe weather alerts, and others.

Machine data 124 may identify one or multiple machines configured to perform work on worksite 36. For each machine, machine data 124 may identify a machine type (e.g., category, such as dozer, grader, haul truck, etc., whether a machine is under manual control, semi-autonomous control, or fully-autonomous control), a machine model (e.g., by model number), a unique machine identifier (e.g., serial number), an availability of the machine (e.g., available to perform work, inoperable, under maintenance), fuel or charge level of the machine, and others. Machine data 124 may also include information relating to machine operations, such as machine slip, traction, dig force, or other data generated based on sensors present on the machine. For example, load on a machine may be determined based on sensors for a hydraulic system that operates to lift material. Density of material may be determined with safety zone analyzer 108 based on density of material determined by the weight of material in a full bucket. Lower material densities may be associated with increased risk of erosion. A global positioning system or other location device may allow this machine operation data to be correlated with a particular location of worksite 36.

Schedule data 126 may correspond to a series of tasks that will be performed on worksite 36 to achieve the desired site condition reflected by models 114. Schedule data 126 may include expected start dates and end dates, or other times, for a particular task (e.g., transfer pile of material) or for a group of sub-tasks (e.g., loading material, hauling material, dumping material) that collectively result in the performance of the task. Schedule data 126 may include a series of tasks that will be performed over a set period of time (e.g., a 6-hour, 8-hour, 10-hour, 24-hour period of time, etc.).

In some aspects, multiple tasks may represented in schedule data 126, these tasks being dependent on each other. Thus, when a completion time of a first task is delayed (e.g., the end time of the task is changed to be later in time), the start time of a second task may be delayed. For example, a compaction task performed with compactor 24 may have a start time that is dependent on completion of a fill task performed with dozer 22 and/or a grade task performed with dozer 22 or grader 18 in which material is prepared for compaction. Thus, when the fill task and grade task are delayed, the compaction task may be delayed.

Personnel data 130 may indicate personnel, such as machine operators, that are available to perform work for a set period of time, such as the period of time described above. In some aspects, particular personnel may be associated with one or a plurality of tasks and/or machines. For example, a first operator may be associated with (e.g., available and trained or certified to perform) filling and/or cutting tasks, while a second operator is associated with compacting, hauling, and/or loading tasks. Personnel data 130 may identify one or more of the machines of system 10 that are associated with particular personnel (e.g., personnel that are available for and trained or certified to operate the corresponding machine).

Cost data 132 may include information indicative of costs associated with performance of work at worksite 36. Cost data 132 may include fuel costs, machine operation costs (e.g., use charges to an owner of the machine), machine depreciation costs, operator costs, and others. Cost data 132 may include information useful to determine or calculate a productivity factor. In some aspects, a productivity factor is determined with work plan generator 138 and represents the amount of work performed at worksite 36 (e.g., material transported, area graded, material filled, etc.) in relation to one or more costs (e.g., fuel cost, machine operation costs, personnel costs, etc.). In particular, cost data 132 may indicate costs associated with delay of one or more tasks included in schedule data 126.

Site model analyzer 136 of safety zone analyzer 108 may be configured to compare two or more models representative of current, previous, and future states of worksite 36. Analyzer 136 may receive models, such as models 112 and 114, that contain data representing points in three-dimensions. Site model analyzer 136 may be configured to correlate portions of the models. Referring to the example shown in FIG. 1, models 112 and 114 may include areas that correspond to material wall 38, loadable material 40, wall 42, material pile 44, etc. These areas may be present in models 112 and not in models 114.

Site model analyzer 136 may determine differences between models 112 and 114. These differences may be identified based on differences between individual points, polygons, surfaces, or areas, between model 112 and 114. As examples, the differences may indicate that a rough surface will be smoothened, a cavity will be filled, a pile of material will be removed, a trench will be created, a foundation will be created, a blasthole will be drilled and/or blasting will be performed, or a road will be created. In particular, the existence of a feature in model 114 that is absent in model 112 may indicate that this feature will be constructed, while the absence of a feature in model 114 that is present in model 112 may indicate that the feature will be removed or otherwise altered.

Site model analyzer 136 may include a physics-based model 140 that assists site model analyzer 136 in determining physical qualities of modeled surfaces. In some aspects, physics-based model 140 is tailored for the type of work that will be performed at worksite 36. For example, physics-based model 140 may be configured to assign material data (e.g., data 116, 118) to materials that define surfaces and/or features of model 112, model 114, or a model representing the differences between models 112 and 114. This material data may reflect properties of material to be excavated, paved, drilled, mined, etc.

Physics-based model 140 may be configured to perform analyses, such as finite element analysis, to identify potentially unsafe areas of a site model. These analyses may be performed based on material density data 116, material type data 118, topology data 120, and environmental data 122. Site model analyzer 136 may associate one or more of these types of data with particular locations of models 112. These particular locations may be analyzed using finite element analysis or other techniques of physics-based model 140 to identify likelihood of erosion, material shifts, wall collapse, material slump, runoff, or to adjust material density or material type.

Site model analyzer 136 may be configured to output data based on the comparison of models 112 to models 114. For example, changes in material location, additional features, or removed features, may be output as a difference model (e.g., a model that represents variances between inputs), also referred to herein as a delta model, or in another form. This delta model may be a two-dimensional or three-dimensional representation of the current worksite, indicating one or more areas or features that are intended for modification, in addition to one or more areas that will not be modified. In some aspects, material density data 116, material type data 118, topology data 120, and environmental data 122 may be associated with one or multiple portions of the delta model output with site model analyzer 136.

Work plan generator 138 may be configured to receive and analyze the delta model that is output from site model analyzer 136. Work plan generator 138 may be configured to process the delta model to generate safety zones that are associated with one or more areas of the above-described delta model or site model 112. If desired, work plan generator 138 may include a machine learning model (e.g., machine learning model 142, as described below) that assigns safety zones to the delta model. In the illustrated embodiment, site model analyzer 136 includes physics-based model 140 for determining physical characteristics of worksite 36, site model analyzer 136 operating in conjunction with machine learning model 142 of work plan generator 138. However, in at least some configurations, site model analyzer 136 includes machine learning model 142 in addition to physics-based model 140 or instead of physics-based model 140.

Work plan generator 138 may include model analysis algorithms, such as a machine learning model 142, configured to receive the delta model and one or more of work inputs 134. While work inputs 134 are shown as being separate from the delta model in FIG. 2, if desired, one or more of work inputs 134 (e.g., material density data 116, material type data 118, topology data 120, environmental data 122, or other data of inputs 134) may be received by machine learning model 142 as part of (e.g., incorporated in) the delta model. When work inputs 134 are received separately from the delta model, work plan generator 138 may be configured to associate each type of data received via inputs 134 with one or multiple regions of the delta model.

Machine learning model 142 may perform functions that allow prior data to assist with prediction of potentially unsafe areas. These functions may be performed with a hazard analyzer (e.g., for identification or classification of hazards, including potentially dangerous areas of the delta model), a caution area generator for creating areas where machine speed is restricted, machine type is restricted, etc., a limitation area generator for generating areas that are limited to a particular number of machines, a prohibition area generator that prohibits manually-operated machines, semi-autonomously-operated machines, or other types of machines, from one or more areas (e.g., limiting an area to fully-autonomous machines) or that determines areas in which no machines or operators are permitted, etc., and an optimization engine that takes into account machine data 124, schedule data 126, personnel data 130, and cost data 132, and determines cost-reducing strategies based on a cost function or other optimization algorithm.

Machine learning model 142 may be configured to receive work inputs 134 and to generate outputs that include safety zones (e.g., caution areas, limitation areas, prohibition areas, etc.), a current zone sequence (e.g., areas of the delta model in which tasks are to be performed in a sequence set by machine learning model 142, as described below), and machine assignments that associate particular machines with, e.g., load areas, unload areas, or other locations of worksite 36 where work will be performed.

Machine learning model 142 or other modules of work plan generator 138, or if desired, physics-based model 140, may be implemented as a machine learning model. Machine learning models described herein may be trained based on known outcomes, or other inputs, relating to a work plan, safety zones, and/or work zone sequences. Inputs may be from any applicable source including prior work plans, text, visual representations, data, values, comparisons, etc.

Known outcomes may be included for the machine learning models generated based on supervised or semi-supervised training. An unsupervised machine learning model may not be trained using known outcomes. Known outcomes include known or desired outputs for future inputs similar to or in the same category as inputs that do not have corresponding known outputs. In the example of a machine learning model 142 trained for identifying safety zones for excavation, known outcomes may correspond to physical features (e.g., material density, material type, topology data, etc.) that are known to represent an unsafe condition.

The training data and a training algorithm, e.g., one or more modules implemented using the machine learning model and/or are used to train the machine learning model, are applied the training data using the training algorithm to generate the machine learning model. According to an implementation, comparison results are used to compare a previous output of the corresponding machine learning model to apply the previous result to re-train the machine learning model. The comparison results may be used by a training component to update the corresponding machine learning model. The training algorithm may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods, the model specifically discussed herein, or the like. The machine learning model used herein is trained and/or used by adjusting one or more weights and/or one or more layers of the machine learning model. For example, during training, a given weight is adjusted (e.g., increased, decreased, removed) based on training data or input data. Similarly, a layer is updated, added, or removed based on training data/and or input data. The resulting outputs are adjusted based on the adjusted weights and/or layers.

In some aspects, reinforcement learning may be employed to update (e.g., re-train) machine learning model 142. For example, data representing the occurrence of runoff, material collapse, and other known outcomes, when they occur, may be provided as work inputs 134 with associated material density data 116, material type data 118, topology data 120, environmental data 122, machine data 124, etc. Thus, true or known examples of unsafe conditions may be provided to machine learning model 142 to improve the accuracy of future safety zone designations, including safety zone type, size, and location.

Instead of or in addition to re-training, past data may be used to generate safety zones. As an example, past rain damage may be included in data 122. This past damage, or other past environmental data 122, may be analyzed with algorithms employed by site model analyzer 136 or by work plan generator 138 into and compared to current weather or other environmental data 122. A summary may be generated by combining those two data sets together, the summary causing generation of a safety zone or recommending generation of a safety zone. Each other type of safety zone described herein may be determined based on this or other environmental data 122. Further, past damage may be included in data 166, 118, 120, or 124 and compared to current conditions for generation of one or more safety zones, recommendations for safety zones, or recommendations 156.

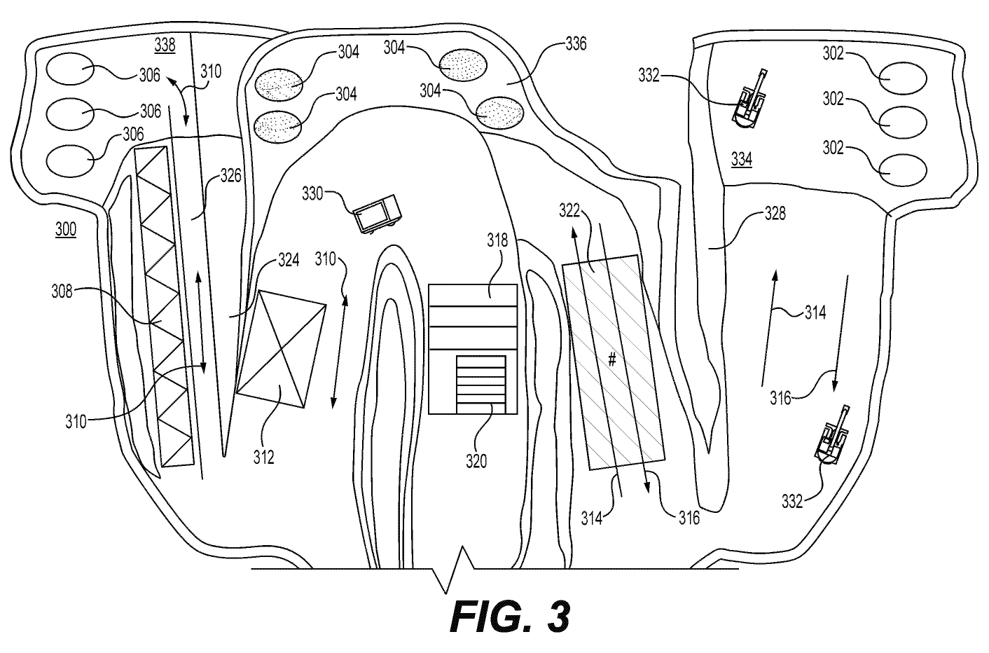

Zone viewer 144 may receive outputs from work plan generator 138, such as safety zones, zone sequences, machine assignments, and others. Zone viewer 144 may allow an operator to view (e.g., via a headset or other display) a view of the safety zones, the current work zone sequence, machine assignments, or other outputs of work plan generator 138. Zone viewer 144 may, additionally or alternatively, cause display of the delta model, models 112, or models 114. The view may be in two-dimensions (e.g., a view from above as shown in FIG. 3) or in three-dimensions (e.g., by use of separate near-eye displays, polarization devices, interference filter devices, other stereoscopic techniques, etc.), the view including a two-dimensional or three-dimensional map of worksite 36. Display of the safety zones and/or other information from safety zone analyzer 108 may be issued as display commands 154 for systems 32 (FIG. 1), systems 34 (FIG. 1), or other devices associated with worksite 36.

Recommendation engine 146 may receive recommendations output from work plan generator 138 and prepare these recommendations for display on a two-dimensional or three-dimensional view. In some aspects, these recommendations may be suggestions for changes to work site plan 152. In some aspects, recommendations 156 from recommendation engine 146 include changes to safety zones, work zone sequences, or operator-machine pairings. Recommendations 156 may also include site modifications or road designs, as indicated in FIG. 2. Site modifications may include changes to machine or operator staging areas (e.g., filling, compacting, or otherwise preparing staging areas), shoring, etc. Road design recommendations 156 may include recommendations to expand existing roadways, changes to a path followed by a roadway, recommendations for new roadways, etc.

Automation manager 148 may be configured to control one or more fully-autonomous or partially-autonomous machines. For example, machine commands 158 may cause a machine to perform tasks including travelling, lifting material, hauling material, dumping material, compacting material, grading material, and others, while complying with each safety zone.

FIG. 3 illustrates a safety zone environment 300 that represents information that may be presented via systems 32 or systems 34. Safety zone environment 300, as shown in FIG. 3, also represents internal computations, designations, and outputs generated with safety zone analyzer 108. Safety zone environment 300 may include areas where work is performed, areas where machines are located or are expected to be located for performing work in the future, travel routes, recommendations, and safety zones. If desired, safety zone environment 300 may show current (e.g., as a view in real-time or near real-time) locations as hauling machine locations 332, loading machine locations 332, or locations of any other machine.

Safety zone environment 300, as shown in FIG. 3, includes visual representations of safety zones and areas where work will be performed. Safety zones represent relative safety of an associated area and include, in the example of safety zone environment 300, safe zone 334, potentially unsafe zone 336, and safe zone 338, as well as other features described in further detail below. Areas where work will be performed include safe loading areas 302, potentially unsafe loading areas 304, and unloading areas 306.

Safety zones may take the form of prohibition areas, caution areas, and limitation areas, as described above with respect to work plan generator 138. Examples of prohibition areas in safety zone environment 300 include potentially unsafe loading areas 304 and prohibited area 312. Safety zones may further include designated two-way route 310, prohibited area 312, one-way route 314, one-way route 316, reduced-speed area 318, reduced-speed area 320, and machine number limitation area 322. Safety zones may be displayed by use of coloring (e.g., a colored overlay placed over an area of environment 300), symbols (e.g., the “#” symbol in FIG. 3 for area 322), text labels, or a combination of these and other graphical elements.

Safety zones may include areas where work will be performed. In the illustrated example, safe zone 334 includes loading areas 302, potentially unsafe zone 336 includes loading areas 304, and safe zone 338 includes unloading areas 306. Safe zones, such as safe zone 334 may be areas where risk of injury to operators and risk of damage to machines is relatively low. Safe zone 334 may be areas, designated by work plan generator 138, where operators are permitted to be present, and where manually-operated or semi-autonomous machines may operate. In some examples, autonomous and manually-operated machines may work in conjunction within safe zone 334.

Potentially unsafe zone 336 may be an area which is potentially unsafe for manual operation and/or for the presence of operators. For example, potentially unsafe zone 336 may include walls 328 that are susceptible to erosion, steep inclines, obstacles, and other potential hazards that are identified with work plan generator 138 based on work inputs 134. In some zones potentially unsafe zone 336, operation may be entirely prohibited until the hazardous condition is remedied. In the illustrated example, autonomous machines may be permitted to travel into and perform work in potentially unsafe zone 336, while operators and manually-operated machines are prohibited from entering and from performing work in potentially unsafe zone 336.

Two-way route 310, one-way route 314, and designated one-way route 316 represent routes that are designated with work plan generator 138. These routes may indicate areas where machines are permitted to move, or caused to move by machine commands 158. In some aspects, machines are permitted, or caused, to travel along routes 310, 314, 316 in a particular direction. Routes 310, 314, 316 may ensure that routes are a minimum predetermined distance from a potentially unsafe area, a retaining wall, a slope, etc. These routes may be designated in a manner that permits travel only in a particular direction (e.g., one-way route 314, designated one-way route 316) or in multiple directions (e.g., designated two-way route 310).

Prohibited area 312 may be an area in which no machines or operators are permitted. Prohibited area 312 may be designated based on a condition of high-slope area 324. For example, high-slope area 324 may present a risk of erosion or even collapse, based on work inputs 134 (e.g., material density data 116, material type data 118, topology data 120, environmental data 122 may be associated with an increased likelihood of erosion). For example, risk of erosion may generally increase with decreased material density reflected in data 116, increasingly loose material or gravel reflected in data 118, increasingly steep inclines and/or decreasing drainage represented in data 120, and increasing quantity of precipitation in data 122.

Reduced-speed area 318 and reduced-speed area 320 represent safety zones in which the propulsion speed of machines is limited. Reduced-speed areas 318, 320 may be present in travel lanes (e.g., roads), work areas, or other locations. As shown in FIG. 3, reduced-speed area 318, 320 may be nested (e.g., one area is contained within another area), overlapping, or separate. In the illustrated example, reduced-speed area 318 is an area where the maximum permitted speed is set to a lower speed than other areas of the worksite and reduced-speed area 320 is an area where the maximum permitted speed is set lower than the speed in area 318. Reduced-speed area 318 may be determined based on work inputs 134, including material density data 116, material type data 118, topology data 120, environmental data 122, and machine data 124.

In some examples, only one machine is permitted to travel along designated two-way route 310 at a particular time. Machine number limitation area 322 may limit a number of machines along one or a plurality of areas or routes. In the illustrated example, machine number limitation area 322 limits the number of machines that are permitted to travel on one-way route 314 and designated one-way route 316, regardless of direction of travel.

Safety zone environment 300 may present recommendations, such as recommendation 308. In the illustrated example, recommendation 308 corresponds to a location for expanding a travel route 326 (e.g., a road) or constructing additional travel routes 326. Thus, recommendation 308 may be a location where a new travel path or other structure may be constructed. Recommendations 308 may be generated to remedy a potential safety issue, thereby causing work plan generator 138 to remove the designation of a safety zone. For example, recommendation 308 may be displayed as a location where a retaining wall may be constructed, maintained, bolstered, etc. Thus, recommendations 308 may be generated to increase productivity (e.g., via increased hauling capacity), increase safety (e.g., by constructing additional reinforcements, shoring, etc.), reduce costs, etc.

As described above, each of the elements in safety zone environment 300 may be presented via a display, for example as a graphical user interface (GUI). In some aspects, a user may modify any of the elements shown in safety zone environment 300 or load progression environment 300. For example, a user may override safety zones, create new safety zones, extend safety zones, or change parameters of safety zones. If desired, a user may modify work inputs 134 or models 112 or models 114 and generate a new work plan based on the modified input(s).

In the example above, safety zones may relate to physical safety of machines and operators, the safety zones being generated to minimize risk of physical harm in these areas of worksite 36. In at least some embodiments, safety zones may be generated to improve air quality, reduce noise, and provide other benefits by way of the optimization engine and other aspects of work plan generator 138 described herein.

### INDUSTRIAL APPLICABILITY

The systems and methods disclosed herein may be applied to any system that is suitable for monitoring a work site, supervising a work site, or planning future work using modelling techniques, machine learning, etc. In some aspects, the disclosed systems and methods may be useful for generating machine commands (e.g., for autonomous vehicle control), or setting parameters for manual or semi-autonomous machine control, including remote control, based on one or more safety zones. Safety zones generated with the disclosed systems and methods may be updated periodically (e.g., monthly, weekly, daily, hourly, etc.) or in real-time or near real-time. As described above, the systems and methods may be implemented via system 32, system 34, or other systems suitable for use with machines 12, 14, 16, 20, 22, and/or 24.

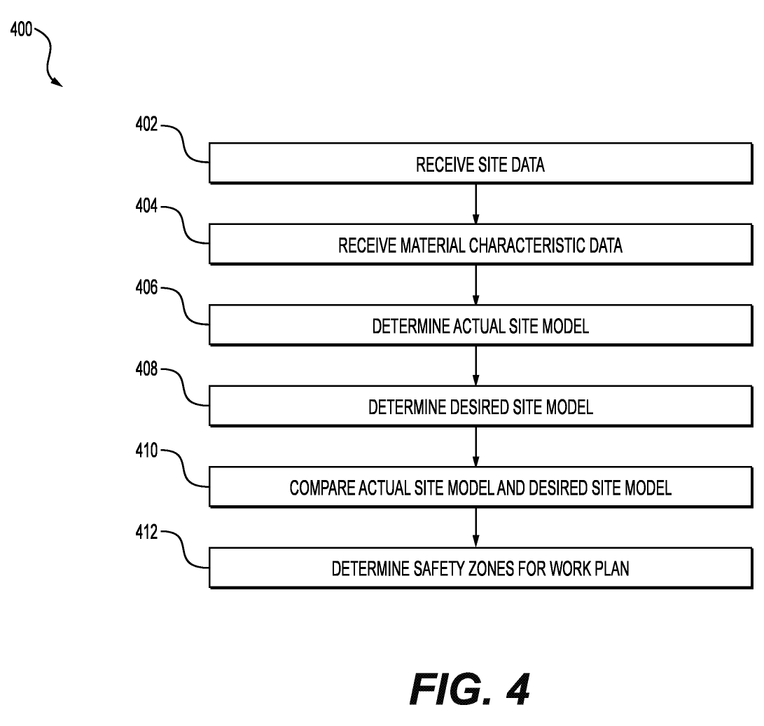

FIG. 4 is a flowchart of a method 400 for determining safety zones. A step 402 may include receiving site data with safety zone analyzer 108. Site data may include survey data, including data for determining models 112. The site data may be collected via drone 30, a ground-traversing rover, and/or machine-vision devices (e.g., light detection and ranging (LIDAR) devices, radar devices, sonar devices, imaging devices) on the machines operating at worksite 36. When site data is collected from one or more machines, the data detected with the machine-vision devices may be correlated with the geographic location of the machine as determined with data from a global navigation satellite system or other positioning system.

The site data may be in the form of images (e.g., satellite or drone photography), as well as a three-dimensional map (e.g., coordinates in three-dimensional space). In some aspects, the images may be fit to points in three-dimensional space, allowing a two-dimensional image or series of images useful for visual presentation of models 112 in three dimensions.

A step 404 may include receiving material characteristic data (e.g., material density data 116, material type data 118). The material characteristic data may be determined based on physical on-site testing (e.g., soil analysis, bore sampling). In some aspects, machine operational data may provide material density data 116 and material type data 118. For example, sensors on the machines may indicate slip, traction, dig force, and others. Suitable sensors for collecting this data include hydraulic system pressure sensors, load sensors, inertial measurement units or other sensors for detecting motion or acceleration, and others. As an example, a dozer may experience slip or failure of a blade to penetrate material, data representing these conditions being generated based on tilt of the machine, position of the blade, speed of the machine, etc. This condition may be correlated with the current position of the dozer, the data being transmitted to safety zone analyzer 108 and processed to update material density data 116 and material type data 118.

A step 406 may include determining an actual site model 112. Actual site model 112 may be determined based on the site data received in step 402. The actual site model may be in the form of a map that represents height information of different locations within the mapped area. The actual site model may represent the current state of worksite 36, and in particular, the state of worksite 36 prior to performing work that significantly changes the topology of worksite 36.

A step 408 may include determining a desired site model 114. Desired site model 114 may represent a design for worksite 36 at the completion of work, or at an intermediate stage after at least some work is performed to alter worksite 36. Desired site model 114 may be in the same or similar format as actual site model 112 to facilitate comparison between the two models. In particular, model 114 may be in the form of a map that represents height information of different locations within a mapped area. Model 114 may represent structures (e.g., existing structures or structures to be built as part of the work site plan), roads, material excavation, mining operations, etc.

A step 410 may include comparing the actual site model to the desired site model. In some aspects, step 410 may include comparing the heights of corresponding points in models 112 and 114. Step 410 may further include identifying structures that are present in desired site model 114 and absent in actual site model 112. In some aspects, step 410 is performed by modifying model 112 by use of modelling software, including implementations of computer-aided design. Differences between models 112 and 114 may indicate locations where work will be performed.

If desired, step 410 may include generating a delta model that indicates the locations where work will be performed. Step 410 may further include assigning material data to locations of the delta model. For example, material type (e.g., clay, gravel, sand, stone, top soil, whether the material is damp, wet, dry, loose, and/or compacted) may be assigned to an entirety of the delta model, or portions of the delta model (e.g., areas where work will be performed, areas where machines will travel, etc.). Material type data may include information suitable for a physics-based model to analyze the delta model.

A step 412 may include determining safety zones for a work plan. The safety zones may be determined with physics-based model 140 or with machine learning model 142. In some aspects, physics-based model 140 and machine learning model 142 operate together to generate safety zones, as illustrated in FIG. 2, with physics-based model 140 generating the above-described delta model and machine learning model 142 generate safety zones based on the delta model.

Safety zones may include caution areas (e.g., reduced-speed area 318, reduced-speed area 320, or potentially unsafe zone 336 in which only autonomous machines are permitted to operate), limitation areas (e.g., machine number limitation area 322, designated two-way route 310), and prohibition areas (e.g., prohibited area 312). In the example of excavation work, the caution areas, limitation areas, prohibition areas, and other safety areas may be determined based on the likelihood of erosion, material shifts, wall collapse, material slump, runoff, or to adjust material density or material type.

Following or during step 412, machines may be autonomously controlled or manually controlled based on the safety zones. In particular, the machines discussed with respect to FIG. 1, and/or other machines, may be autonomously controlled to travel along designated two-way route 310, one-way route 314, and designated one-way route 316. Further, all machines may be prohibited from entering prohibited area 312. At least some types of machines may be prohibited from entering a safety zone, such as potentially unsafe zone 336.

Method 400 may be repeated periodically or continuously. For example, method 400 may include performing steps 410 and 412 in response to receiving updates to the models described with respect to steps 406 and 408. Additionally, steps 410 and 412 may be performed in response to receiving updated site data and/or updated material characteristic data in steps 402 and 404. Updates to these or other inputs 134 (FIG. 2) may cause safety zone analyzer 108 to update safety zones. This may include re-sizing safety zones, moving safety zones, eliminating safety zones (e.g., designating a previously unsafe area as safe), and/or adding new safety zones (e.g., designating a previous safe area as potentially unsafe).

Step 412 of method 400 may further include presenting the safety zones via a display. In some aspects, the displayed safety zones may be displayed on a map as represented by safety zone environment 300. A user may interact with an input device to override safety zones, manually add additional safety zones, change the type of safety zone (e.g., change an existing safety zone to one or more of a caution area, limitation area, or prohibition area), or alter the size of safety zones.

The disclosed system and method may improve safety at a worksite. In particular, the disclosed system and method may improve safety at a work site in which erosion or other safety issues (e.g., air quality, noise) are possible. Soil information may be utilized, for example with physics-based and/or machine learning techniques, to identify one or more safety zones in which risk of erosion or other issues is elevated. Safety zones may be used to designate areas in which human operators are prohibited, reducing or eliminating threat of harm, while allowing work to continue in a productive manner. Further, safety zones may be generated taking into account information generated by the machines that perform work, or by a drone or rover, allowing regular, and in some cases real-time updates. This allows safety zones to be generated in response to changing conditions.

It will be apparent to those skilled in the art that various modifications and variations can be made to the disclosed method and system without departing from the scope of the disclosure. Other embodiments of the method and system will be apparent to those skilled in the art from consideration of the specification and practice of the apparatus and system disclosed herein. It is intended that the specification and examples be considered as exemplary only, with a true scope of the disclosure being indicated by the following claims and their equivalents.

What is claimed is:

1. A method for determining a safety zone, the method comprising:
receiving work site data representing points of a site in which work is to be performed;
receiving material characteristic data, the material characteristic data corresponding to the points of the site represented by the work site data;
determining an actual site model that is a representation of the site at a current time or at a previous time, the actual site model being based on the work site data;
determining a desired site model that is a representation of the site at a future time;
comparing the actual site model to the desired site model to determine a difference model that includes a safety zone in which a machine speed, a machine type, or a quantity of machines, is limited or prohibited, the safety zone being determined based on a material characteristic associated with material that corresponds to the safety zone, the material characteristic being represented in the material characteristic data, one or more areas outside of the safety zone having a different material characteristic; and
determining a work plan based on the difference model, the work plan including the safety zone.

2. The method of claim 1, wherein the material characteristic data includes at least one of material density data or material type data.

3. The method of claim 1, wherein the machine type includes a first machine type and a second machine type, the first machine type being a machine in which an operator is present within a cabin of the machine during operation, the second machine type being a machine which operates without presence of an operator within the cabin of the machine.

4. The method of claim 1, wherein the difference model represents differences between the actual site model and the desired site model, the differences being achieved by performing excavation, paving, or mining.

5. The method of claim 1, wherein the safety zone is a first zone of a plurality of safety zones, the first zone having a first level of restriction, a second zone that at least partially overlaps the first zone having a second level of restriction, the second level of restriction being more restrictive than the first level of restriction.

6. The method of claim 5, wherein the first level of restriction is a first maximum travel speed and the second level of restriction is a second maximum travel speed that is slower than the first maximum travel speed.

7. The method of claim 1, wherein the safety zone is a prohibition that prevents machines from entering the safety zone, the prohibition being determined based on a potential for erosion.

8. The method of claim 7, wherein the potential for erosion is determined based on environmental data and at least one of material density data or material type data.

9. The method of claim 1, wherein the actual site model is generated with work site data that was generated based on a survey of the site performed with a flight-capable survey device or a ground-based survey device.

10. The method of claim 1, further including causing display of the safety zone via a two-dimensional or three-dimensional representation of the site.

11. A system for predicting conditions of one or more components of a machine comprising:
one or more processors; and
at least one non-transitory computer readable medium storing instructions which, when executed by the one or more processors, cause the one or more processors to perform operations comprising:
receiving work site data representing points of a site in which work is to be performed;
receiving material characteristic data, the material characteristic data corresponding to the points of the site represented by the work site data;
determining an actual site model that is a representation, in three dimensions of the site at a current time or at a previous time, the actual site model being based on the work site data;
determining a desired site model that is a representation, in three dimensions of the site at a future time;
based on the actual site model and the desired site model, determining a safety zone in which a machine type or a quantity of machines is limited or prohibited, the safety zone being determined based on a material characteristic associated with material that corresponds to the safety zone, the material characteristic being represented in the material characteristic data, one or more areas outside of the safety zone having a different material characteristic; and
causing display of a representation of the safety zone on the site.

12. The system of claim 11, wherein the safety zone prohibits operators from the safety zone.

13. The system of claim 11, wherein the safety zone is present in an area of the site in which loading of material is to be performed, unloading of the material is to be performed, grading is to be performed, paving is to be performed, drilling is to be performed, or mining operations are to be performed.

14. The system of claim 11, wherein the operations further include determining a work zone sequence based on the safety zone.

15. The system of claim 11, wherein the operations further include determining a work zone sequence based on material density data, material type data, topology data, or environmental data.

16. The system of claim 11, wherein the operations further include generating a recommendation for a site modification.

17. A non-transitory computer readable medium, the non-transitory computer readable medium storing instructions for predicting conditions of one or more components of a machine which, when executed by one or more processors of a computing system, cause the one or more processors to perform operations comprising:
receiving work site data representing points of a site in which work is to be performed;
receiving material characteristic data, the material characteristic data corresponding to the points of the site represented by the work site data;
determining an actual site model that is a representation, in three dimensions of the site at a current time or at a previous time, the actual site model being based on the work site data;
determining a desired site model that is a representation, in three dimensions of the site at a future time;
comparing the actual site model to the desired site model to determine a difference model that includes a safety zone in which a machine speed, a machine type, or a quantity of machines, is limited or prohibited; and
determining a work plan based on the difference model, the work plan including the safety zone and a work zone sequence.

18. The non-transitory computer readable medium of claim 17, wherein the operations further include updating the safety zone based on a change to the material characteristic data, a change to environmental data, a change to machine data, or a change to personnel data.

19. The non-transitory computer readable medium of claim 17, wherein the operations further include generating a recommendation for modifying the site.

20. The non-transitory computer readable medium of claim 17, wherein the operations further include causing display of a representation of the safety zone and the work zone sequence.
